(19) United States
(12) Patent Application Publication
(10) Pub. No.: US 2012/0060141 A1
(43) Pub. Date: Mar. 8, 2012

(54) INTEGRATED ENVIRONMENT FOR SOFTWARE DESIGN AND IMPLEMENTATION

(76) Inventors: HILMAR DEMANT, Karlsdorf (DE); Abdul Aziz, Bangalore (IN); Debobrata Bose, Kolkata (IN); Indranil Dutt, Bangalore (IN); Mahesh Gopalan, Bangalore (IN); Niels Hebling, Schriesheim (DE); Jayakanth R, Edayar Pakkam (IN); Vinod S. Nair, Palakkad (IN); Aaby Sivakumar, Kollam (IN)

(21) Appl. No.: 12/876,114

(22) Filed: Sep. 4, 2010

(51) Int. Cl. G06F 9/44

(52) U.S. Cl. 717/101

(57) ABSTRACT

Systems and methods for providing an integrated computer environment for software design and implementation are described. A number of UI components are connected in several sequences in the integrated computer environment. Each sequence describes a screenflow corresponding to a particular task in a software application. The screenflows are combined in a normalized interaction diagram representing the sequences of screens for every task that could be performed in the software application. The interaction diagram aggregates the similar UI components in different screenflows to avoid redundant duplicates. The UI components are bound to at least one business object (BO) as defined in a backend computer system. The software application is implemented and ready to be executed after the binding.

### TECHNICAL FIELD

The field of the invention relates generally to data processing and digital processing systems. More specifically, the invention is related to design and implementation of software applications within an integrated computer environment.

### BACKGROUND

The lifecycle of a software application includes different stages, usually starting with an idea or a business request, and going through phases like development, implementation, maintenance, archiving and retirement. Typically, different specialists or stakeholders are involved during each stage or phase of the software application lifecycle. There are different software tools, specially developed to facilitate the different groups of stakeholders to perform tasks pertinent to the different phases. For example, there are various user interface (UI) designer tools, developed and marketed to assist software designers in creating user interfaces for various software applications. Other tools, like business object (BO) editors, help binding the elements of the created UI designs to backend data structures and functionality.

In general, at every stage of a software application lifecycle, there is a set of software tools helping the responsible stakeholders. Sometimes, software tools that are developed by different vendors are involved during the lifecycle phases of the same software application. Situations in which different tools are involved are usually characterized with higher risk for the processes, and higher maintenance costs. Even when the different software tools are developed by a single vendor, or when the tools are proprietary solutions, there are variety of potential issues that may arise. For example, inconsistency in operations may occur when a software application changes its lifecycle phase, and one group of responsible stakeholders is replaced by another group of stakeholders working with different software tools on tasks related to the same application. Therefore, the software vendors are motivated to resolve the potential conflicts and inefficiencies by developing synchronization mechanisms between the stakeholders and the different software tools they are using.

Often, the software tools provided to facilitate lifecycle management of software applications include components based on different technology frameworks. This leads to a higher total cost of operations, especially in computing environments with a high number of customers. Additionally, the detection and fixing of errors is difficult due to the amount of technology involved by layers and components. There is one more negative aspect of the current solutions concerning the innovation turnover. The cycle from an idea to delivery of a ready to use software application is prolonged due to the usage of different software tools, often provided by different vendors, and operating in a complex technology framework environment.

### SUMMARY

Various embodiments of systems and methods for providing an integrated computer environment for software design and implementation are described herein. In one aspect, a number of UI components are connected in several sequences in the integrated computer environment. Each sequence describes a flow of screens, e.g., a screenflow, corresponding to a particular task in a software application. In another aspect, the screenflows are combined in a normalized interaction diagram representing the sequences of screens for tasks that could be performed in the software application. The interaction diagram aggregates the similar UI components used in different screenflows for performing different tasks to avoid redundant duplicates. In yet another aspect, the UI components are bound to at least one business object (BO) as defined in a backend computer system, where the integrated computer environment and the backend computer system are connected via computer network. Metadata describing the interaction diagram and the binding of the UI components to the at least one BO is stored in the backend computer system.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating an environment for software design and implementation, according to one embodiment.

FIG. 2 is a block diagram illustrating lifecycle phases of a software application, according to one embodiment.

FIG. 3 illustrates a process for software design and implementation, according to one embodiment.

FIG. 4A illustrates exemplary graphical user interface (GUI) screens of an integrated environment for software design and implementation, according to one embodiment.

FIG. 4B illustrates exemplary GUI screens of an integrated environment for software design and implementation, according to one embodiment.

FIG. 4C illustrates exemplar GUI screens of an integrated environment for software design and implementation, according to one embodiment.

FIG. 5 illustrates an exemplary GUI of an integrated environment for software design and implementation, according to one embodiment.

FIG. 7 illustrates an exemplary GUI of an integrated environment for software design and implementation, according to one embodiment.

FIG. 8 is a block diagram of an exemplary computer system to execute computer readable instructions for data lifecycle cross-system reconciliation, according to one embodiment of the invention.

### DETAILED DESCRIPTION

Embodiments of techniques for providing integrated environment for software design and implementation are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

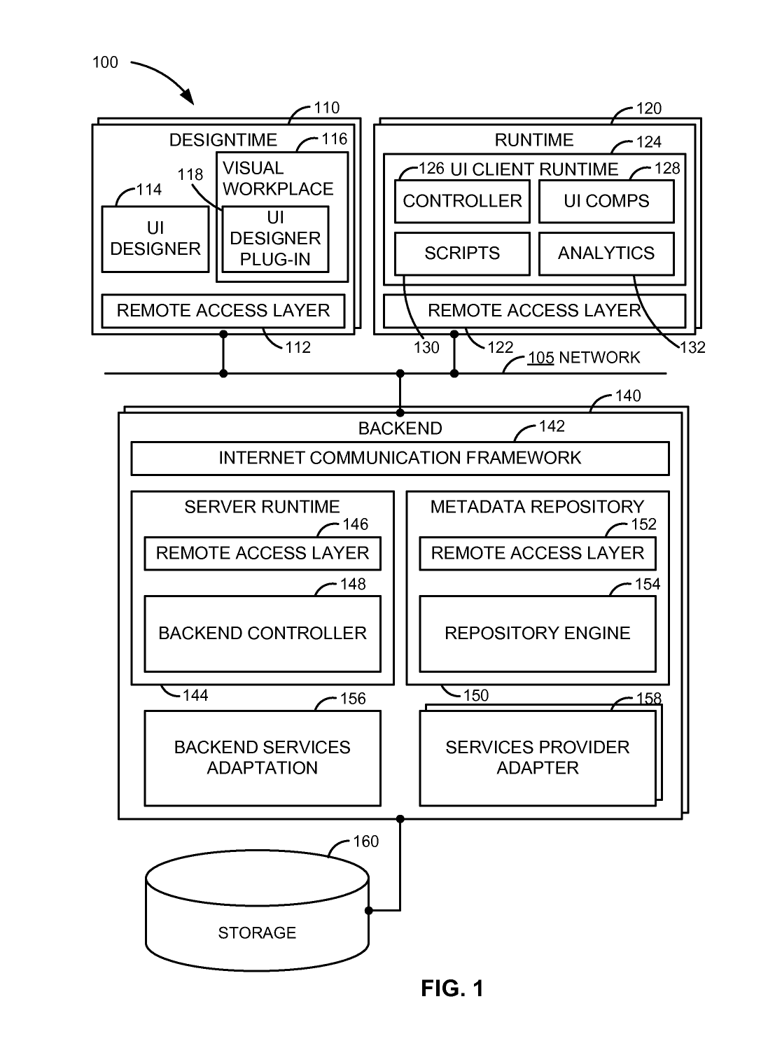

FIG. 1 is a block diagram showing a computer environment 100 where a software application is originally designed, developed, implemented and executed, according to one embodiment. One or more shareholders, e.g., UI designers, software developers, etc., operate within designtime environment 110. Each shareholder may access a dedicated designtime environment 110, or a group of shareholders may share the same designtime environment 110. When implemented, the software application is executed within runtime environment 120. One or more users have access to the services provided by the software application through a single instance of the runtime environment 120. Additionally, different users may access different instances of the runtime environment 120.

In one embodiment, the designtime environment 110 and the runtime environment 120 are integrated in internet browsers running on client computer systems. An intermediate layer between the user and the server may be downloaded to a client computer as an extension of a running internet browser. This intermediate layer, also called “client engine”, takes over responsibility for rendering the necessary client functionality and for the communication with backend 140 via network 105. In the designtime environment 110, the client engine is represented by remote access layer 112, UI designer 114 and UI designer plug-in 118. The remote access layer 112 services the communication with the backend. The UI designer 114 and UI designer plug-in 118 create environment covering the full UI creation process from early mockup to final model deployment. In one embodiment, the UI designer plug-in 118 may extend the functionality of visual workplace 116. The visual workplace 116 may be a part of any popular browser integrated framework, e.g. Silverlight™ provided by Microsoft® Corp, Flex™ provided by Adobe® Systems Inc., JavaFX™ originally developed by Sun® Microsystems Inc., etc. As an alternative, the visual workplace 116 may be a desktop application, for example, a .NET™ application rendering a UI through a Windows Prosecution Foundation (WPF) system.

In runtime environment 120, client engine includes remote access layer 122 to handle the communication with the backend 140. Further, the client engine includes UI client runtime 124 that may also embed into a browser integrated framework, e.g. Silverlight™, etc. In one embodiment, the UI client runtime 124 runs in a web browser and interprets UI models created within the designtime environment 110. The client runtime 124 accesses the necessary business data at the backend 140 through remote access layer 122 and network 105. No dedicated UI server or client programs are needed. The communication with the backend 140 may include extracting, storing or updating data. The data may be transported to storage 160, especially when backend 140 is implemented on a number of servers.

In one embodiment, a user triggers a service request at UI client runtime 124. UI components module 128 instantiates one or more appropriate UI screens or controls in response to the user request. The behavior of the UI components is managed by controller 126. The controller 126 makes sure that all instantiated controls in the UI components 128 are initialized. The controller is also responsible for the execution of any configured operation triggered by events corresponding to the instantiated controls. In case when some of the operations involve execution of script segments, the controller 126 may trigger the execution of these scripts via scripts 130. In one embodiment, scripts 130 is a frontend scripting engine. Analytics module 132 may be used for frontend data processing when necessary.

In one embodiment, the backend 140 utilizes internet communication framework 142 to connect to the Internet or to another public or private network. Server runtime 144 couples to the runtime environment 120 through remote access layer 146. In one embodiment, the server runtime 144 generates backend controller 148 for a session to handle every requested UI component, when the UI client runtime 124 triggers an initialization of a UI component for the first time in the session. The backend controller 148 manages the collaboration between the requested UI components, the relevant metadata, and the underlying business objects.

Metadata repository 150 keeps description of the available UI components and the relationships between them as defined through the designtime environment 110. The communication between the metadata repository 150 and the designtime environment 110 may be handled by remote access layer 152. Repository engine 154 manages the metadata and the collaboration with the server runtime 144 at one hand, and with a number of service providers at the other hand. The service providers render the UI components to the backend 140 as defined in the metadata. The service providers are available via service provider adapters 158, and can be either internal or external to the backend 140. In one embodiment, backend services adaptation 156 is a layer that helps to adjust the designed UI components to a set of normalized business objects provided at the backend 140.

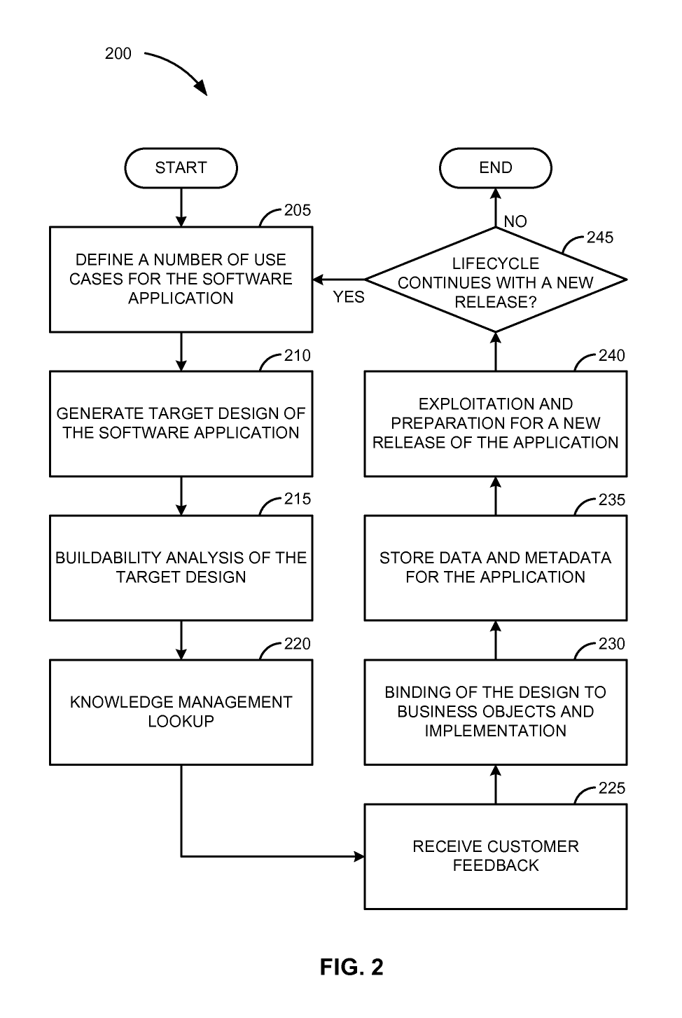

FIG. 2 shows a block diagram 200 of the main lifecycle phases included in a software application, according to one embodiment. Typically, for every lifecycle phase a group of responsible stakeholders may be specified, and the stakeholders may use software tools appropriate to the lifecycle phase. At 205, the lifecycle of the software application starts with an initial phase characterized with defining and describing use cases. The term “use case” addresses desired functionality or behavior of the future software application in a given set of circumstances. Further, the term “use case” may include also a description of the circumstances and the desired behavior. During this phase, relevant documents are created and collected for analysis. An intense collaboration between the customers requesting the software application and the solution managers characterizes the process of use case definition. A solution manager stakeholder may also define new use cases based on feedback from previous releases of the software application.

In a next phase, at 210, a target design of the software application is generated based on the described use cases. The target design is usually a result of a common effort between solution managers, stakeholders and the responsible UI designer stakeholders. The creation of a target design is a complex process starting with generating basic mock-up models of the UI screens. At the end of this phase, the result is a detailed target design of the UIs covering the required functionality of the software application. The target design includes detailed definition of every UI component, including properties, behavior and detailed relationships to other UI components. Also, in the target design, the entities affected by a use case, and the interactions between the entities are identified. This may happen before or in parallel with designing dedicated mockups fulfilling the use cases from a UI perspective.

At 215, the target design is communicated with the assigned software developer-stakeholders who examine the design to create a strategy for building the required functionality within the currently used software and system frameworks. The target design may be altered in order to fit into these frameworks and the existing software building methodology. Any change of the target design requires collaborative iterations between the UI designer stakeholders and the software developer stakeholders. At 220, the terminology that is used in the designed UI screens, in the UI components, and in the associated documentation is checked by knowledge management stakeholders for relevancy with customer's expectations and needs. For example, a lookup for consistency in the terminology is performed, and a database with terms and terms translations is created or reviewed. At 225, the solution manager stakeholders collect feedback from the customers about the designed application, this process eventually triggers iterations on some of the previous phases.

The approved software application design is mapped or bound to a backend model at 230. For example, the designed UI components are bound to one or more business objects or adapted business objects, e.g., business object views defined in a backend system environment. The mapping or the binding of the application design to real business objects, e.g., to data fields, methods, contexts, interfaces, etc., finalizes the implementation of the software application. In one embodiment, the implementation of the software application is not a separate process corresponding to a lifecycle phase, as it happens during the design and binding lifecycle phases. Once implemented, the software application is formally handed over to customers. In one embodiment, the implementation adds controller-logic, e.g., for executing frontend script to calculate values and metadata (e.g., states including “enabled”, “visible”, “read-only”, etc.). The controller-logic may also wire backend actions from the UI, e.g., BO actions, queries, create-read-update-delete (CRUD) methods, to a respective controller and backend functionality of the framework and the specific BOs.

At 235, the data and metadata created during the previous phases of the lifecycle of the software application are stored in a permanent storage, where they can be archived. The implementation of the software application does not stop the development process. During the next phase at 240, a set up for a new release of the application is prepared based on feedback received from the customers using the application, or based on new application requirements. This phase could be regarded as last for the software application lifecycle. After this phase, a decision has to be made whether to continue with a new release of the software application, or whether to retire the application.

There are different shareholders involved with the different phases of the lifecycle of a software application as illustrated with FIG. 2. The different shareholders could be separated in groups, e.g., customers, solution managers, UI designers, application developers, etc. Usually, individual stakeholders from the same or different groups have to work together and cooperate to perform the tasks required at the different phases. For example, one UI designer may be responsible for one of the application screens, and another UI designer for another of the screens. In one embodiment, different individual shareholders from different groups use a single integrated software tool to perform the tasks required for design and implementation of a software application at the different lifecycle phases of the software application. A shareholder in his role can start with different entities to enter the system, e.g., the shareholder can start with a dedicated use case and find all relevant UI components affected by this use case. The same applies for entities like screenflows, projects, affected business objects etc. The shareholder can start with any entity, like a project, and get all referenced entities from there as well. In other words, starting with any entity, it is possible to reach other linked entities within the same working environment.

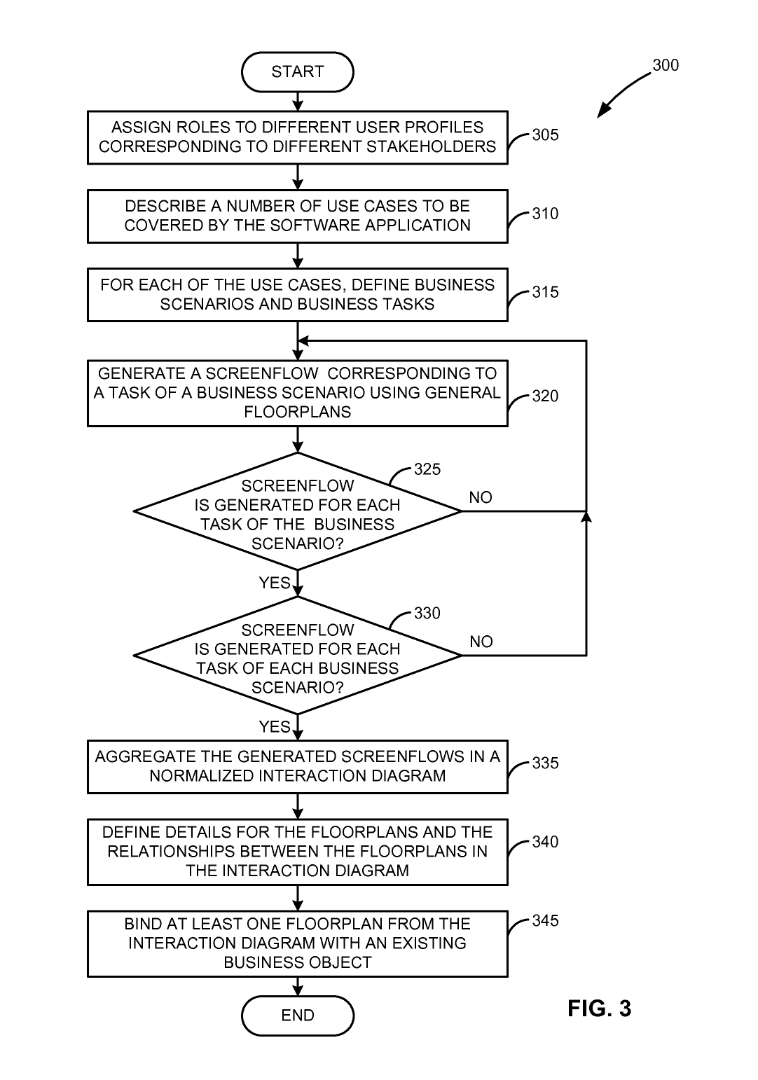

FIG. 3 shows a process 300 for design, development and implementation of software applications within an integrated computer environment, according to one embodiment. A simple definition for an integrated computer environment for the purposes of this document would be a set of services accessed through internet browsers. In one embodiment, the integrated computer environment is a software tool having architecture similar to the architecture illustrated in FIG. 1.

At 305, roles are assigned to different stakeholders involved in performing tasks pertinent to the different lifecycle phases. In one embodiment, different strategies in assigning roles or for defining user profiles may be applied. In one embodiment, different set of operations may be assigned to different roles. One or more user profile types may be defined, associated with one or more roles. The different users of the integrated environment may use different user profiles. Further, individual operations may be assigned to individual user profiles as well. Thus, a single user may have individually assigned roles and user rights to perform particular tasks. In one embodiment, the role definition concept may be project based, e.g., defined based on a “container”-project for entities. For example, in the context of one project a shareholder may act as a developer of an entity, and for another project, the same shareholder may act as a “project lead” with read and test rights, and without the privileges to change details etc. The roles and user profiles may be defined and assigned by an administrator of the integrated environment.

At 310, a number of use cases relative to a prospective software application are described. In one embodiment, the integrated environment may provide intuitive wizard graphical tools to facilitate the description of the use cases. For example, a step by step guide may help to describe a specific business situation in which the software application should operate. In the same time, the tool may provide means to store and order any messages, documents or any other form of information for the use cases. The descriptions of the use cases and the related information may be organized in folders to act as a central hub for collaboration across all participants, e.g., stakeholders, in the process.

Process 300 continues at 315, where one or more business scenarios are defined for each of the described use cases. In this document, the term business scenario addresses series of actions for achieving a specific business goal. The business scenarios may be further divided to one or more business tasks. A business scenario may include a number of sequential or parallel, e.g., alternative, tasks. In one embodiment, the actions for performing a business scenario task would be performed by the software application during runtime with the help of a sequence of UI screens. Therefore, at 320, a screenflow is generated by connecting a number of floorplans. The generated screenflow corresponds to a task of a selected business scenario from the defined business scenarios.

The floorplans are building blocks that may include one or more components. Some of the components of a floorplan have graphical representation, and may be displayed during runtime, e.g., UI controls, data fields, etc. Other floorplan components cannot be displayed as they do not posses display properties. In one embodiment, the group of components without graphical representation may include methods, interfaces, etc. The screenflow generated at 320 may link a number of UI components of at least two different floorplans based on high level dependencies between the floorplans. A screenflow may be defined as a click-through path leading a user of the software application from one UI screen or component to another during runtime, providing the necessary data or entry fields to fulfill the underlying business scenario task.

In one embodiment a set of general or basic floorplans may be defined. A general floorplan may be characterized by its main UI component. A number of general floorplans may be selected from the set of predefined floorplans to generate the screenflow at 320. At 325, it is verified whether a screenflow is generated for each task of the selected business scenario. If not, a screenflow corresponding to another task of the selected business scenario is generated at 320. When screenflows are defined for all tasks in the business scenario, it is verified whether screenflow is generated for each task of each business scenario of the group of business scenarios. In case there are business scenarios, and business tasks, respectively, for which screenflows are not generated, process 300 loops at 320 to generate a screenflow for a business task of such a business scenario.

At 335, the generated screenflows are aggregated in a normalized interaction diagram. In one embodiment, it is not necessary to generate a screenflow for each task in every business scenario defined. A stakeholder in the process 300 may decide how many screenflows are enough to generate an initial interaction diagram for the software application. More screenflows may be aggregated to the interaction diagram at a later point. For example, new screenflows may be added, or old screenflows may be excluded from the interaction diagram due to changes to the business scenarios, or due to a definition of a new task, etc. In one embodiment, even if no screenflows are defined, interaction diagram is possible to be computed based on detailed component modeling. In such a case, the interaction points between components are presented as sub-entities. The interaction points refer to the same elements and manipulate the same data, regardless how they are displayed or presented. For example, a new interaction point may be defined either in a screenflow, or as a UI component referring the same element instance inside the screenflow or the UI component.

In this document, the meaning of “normalized” in the context of an interaction diagram means that duplicated floorplans should be avoided. In other words, when two or more screenflows use a same general floorplan having the same main UI component, only one such floorplan is included in the interaction diagram, when possible. Thus, one floorplan in the interaction diagram may participate in several tasks and even in several business scenarios. In one embodiment, the interaction diagram represents a high level architecture of the software application. An analogy can be construed between the interaction diagram and a directed graph. The nodes of the graph would correspond to the floorplans of the interaction diagram, and the graph edges would correspond to the relationships between the floorplans, e.g. to the click-through paths.

In one embodiment, the interaction diagram may have details showing which screenflows are participating, and drill down capabilities into related entities including screenflows, use cases and UI components. The interaction diagram may include features allowing analysis of analogies, e.g., to evaluate which routes are heavily used and eventually represent core functionality. Further, rules based on conditions may be defined. For example, it could be secured that there will be always two ways to reach from an object worklist (OWL) item to a factsheet, e.g., via a link and via a button in the toolbar. In a more advanced embodiment, data could be collected from an actual running application instance into the interaction diagram to show the main components and navigation paths used by one or more users. The data for the running application instance may be collected during further iterations of a same software project to discover and analyze critical functionality, to re-design the application, to define and add new usability features etc.

At 340, details are defined for the floorplans, and for the relationships between the floorplans. The design of the original floorplans is elaborated to suit the specific needs of the customers of the software application. Additional UI components and components that do not have visual representation are defined. A set of characteristics for the different floorplan components are defined, including the component behavior, shapes and dimensions, etc. The relationships between floorplans and the dependencies between floorplan components are specified in details as well. In one embodiment, the detailed specification of the floorplans and the relationships between floorplans conforms with an established set of requirements that may derive from imposed design standards or from various system framework constraints.

Process 300 ends at 345, where at least one floorplan from the interaction diagram is bound to one or more business objects defined in an application platform backend. The one or more business objects may be globally defined and shared by more than one software applications. Metadata describing the business objects may be accessed at the backend computer system. In one embodiment, the detailed definition of the floorplans of the software application, the relationships between the floorplans, and the binding between the floorplans and the business objects are also described in metadata accessible at the backend system. The metadata regarding the floorplans and the relationships between the floorplans of the software application may be persisted at the backend system automatically while being defined by the responsible stakeholders within the integrated computer environment. According to one embodiment, the binding of the floorplans is equivalent to software application implementation, and once completed, the application is ready to be executed in runtime mode.

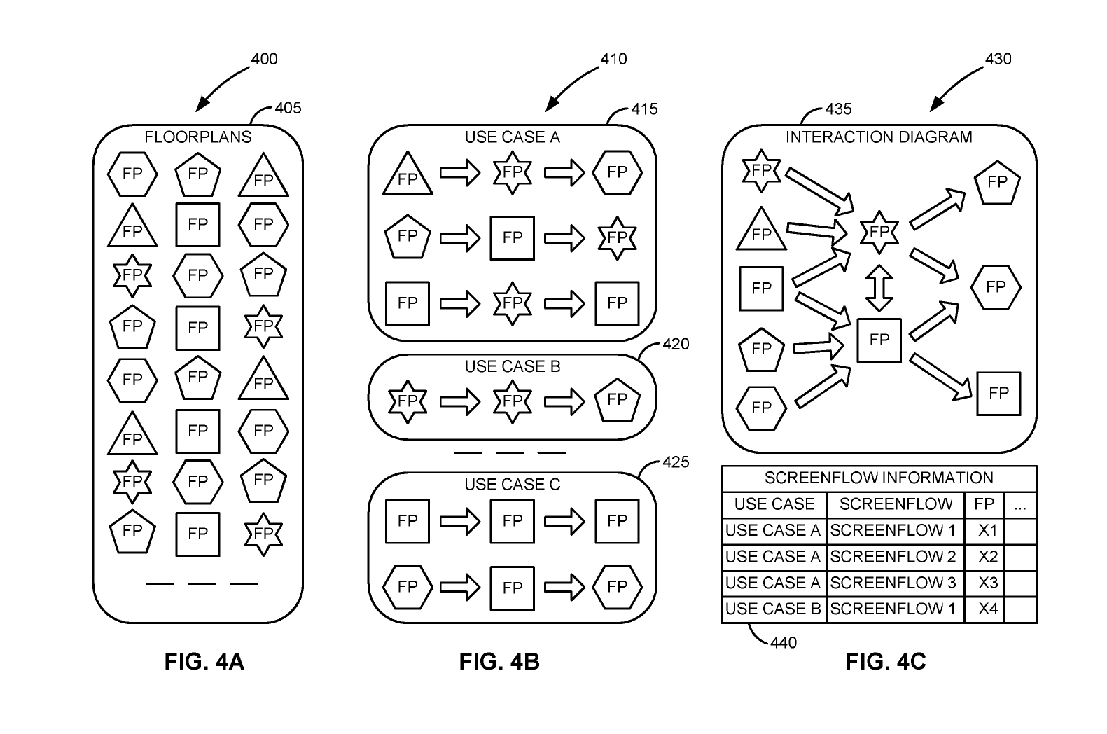

FIG. 4A, FIG. 4B and FIG. 4C show exemplar graphical user interface (GUI) screens to be displayed by the integrated computer environment during the screenflows design, according to one embodiment. In FIG. 4A, GUI 400 includes screen 405 where a number of general floorplans are grouped. The general floorplans may be characterized by one or more main UI components, and respectively divided in subsets by types.

FIG. 4B shows GUI 410 including a number of screenflows built by connecting general floorplans into sequences. The screenflow represent a high-level application process flow as it would appear to the end users of the software application, involving the main UI elements of the general floorplans. In one embodiment, each of the screenflows correspond to a task of a business scenario, and respectively, of a use case. The illustrated screenflows show sequences of three floorplans, but the number of floorplans in the sequences may vary depending on the underlying tasks.

In one embodiment, the screenflows may be grouped in different screens 415, 420 and 425 of the GUI 410. The number of the screenflows may correspond to the number of the specified business scenarios, or to the number or the specified use cases. The screenflows in a group correspond to some or all of the tasks of a single business scenario or a use case. The GUI 410 may display only one of the screens 415, 420 and 425 at a time, or the GUI 410 may display a subset of the screens 415, 420 and 425. Any of the displayed screens 415, 420 and 425 may include only a subset of the designed screenflows.

FIG. 4C shows GUI 430 where a number of high-level designed screenflows are integrated into an interaction diagram in screen 435. In one embodiment, the duplicated floorplans of the same type are automatically normalized in the interaction diagram to minimize their number whenever possible. Thus, a single floorplan may participate in several screenflows. It may become hard for a stakeholder to follow and analyze the integrated screenflows. Therefore, an additional screen or a screen area 440 may be added to the GUI 430 to enlist the screenflows included in the interaction diagram.

In one embodiment, a screenflow may be selected from the list of screenflows in the area 440, and the corresponding floorplans with the relationships between them may be highlighted in the interaction diagram in screen 435. Alternatively, when a floorplan in the screen 435 is selected, the screenflows in which the floorplan is included are highlighted in the screen 440. Other “select-highlight” correlations between the information in screens 435 and 440 may be defined.

High-level interaction diagrams describe the main components of a software application. Generally, it specifies the basic UI screens of the application, and the navigation between the UI screens depending on user actions and system events. For each of the involved floorplans, further details may be provided within the integrated computer environment. For example, defining floorplan components at low level and specifying their properties.

In one embodiment, a floorplan is a self contained UI model that can be declaratively used in another UI model as well. The floorplans are UI components that may also include non-visible software components. Some of the floorplans may be composite, e.g., composed out of other components. Other floorplans cannot be composite. For example, a floorplan may be a UI control that cannot include other components. A composite floorplan may combine several UI controls or other nested components.

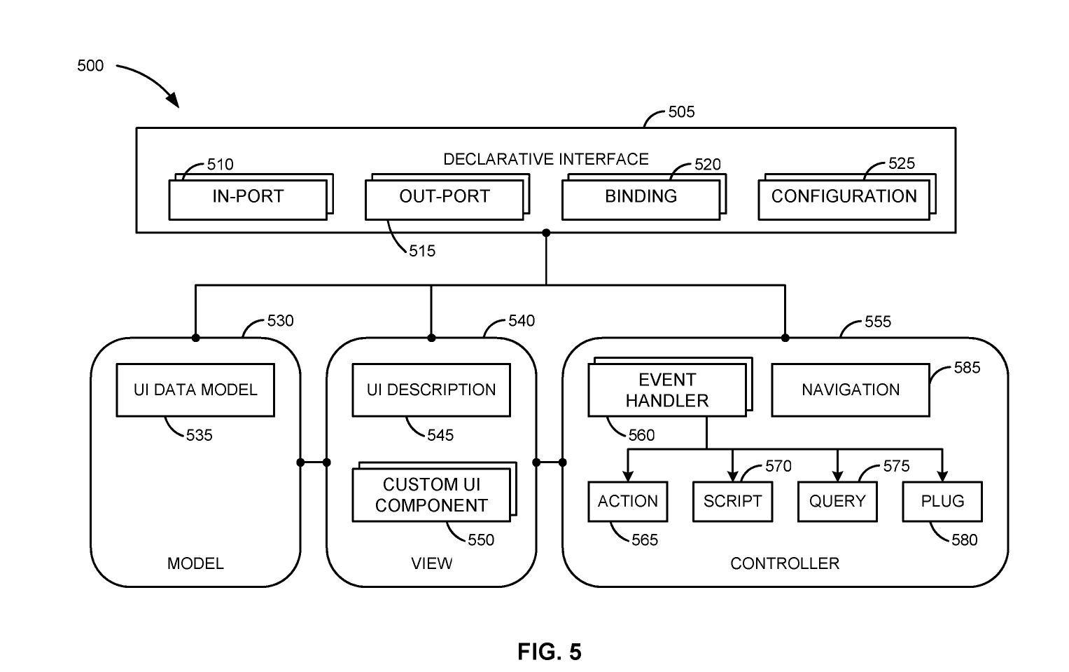

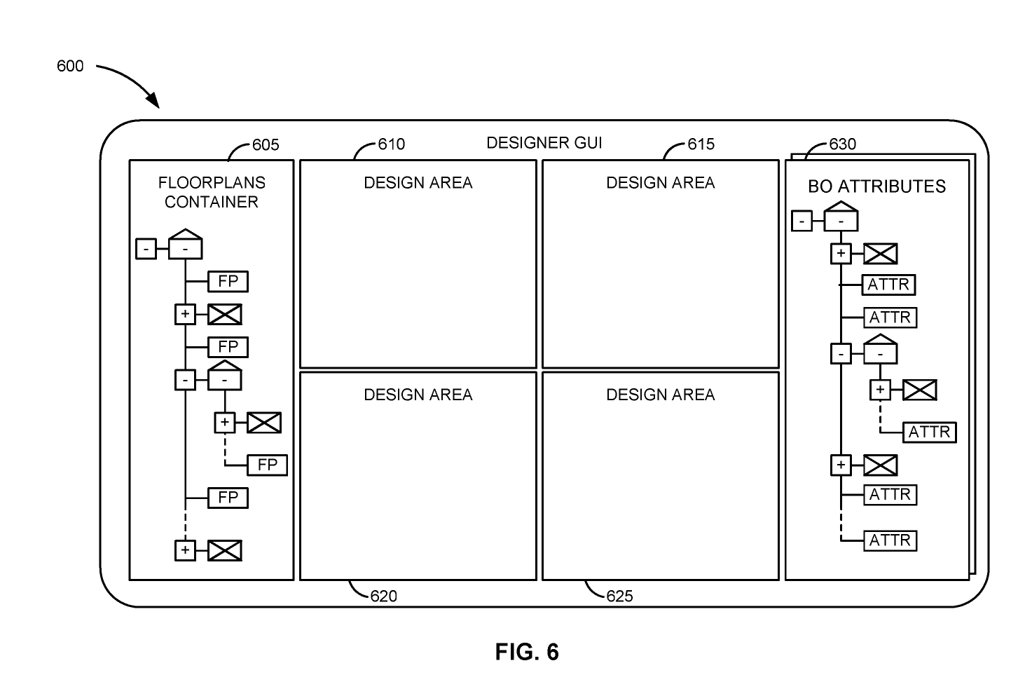

FIG. 5 shows the structure of component 500, either composite or not, according to one embodiment. Component 500 may be a general floorplan component or any other UI component declared in the integrated computer environment. The main modules of the component 500 are declarative interface 505, model 530, view 540 and controller 555. The integrated computer environment may interact with the declarative interface 505 of the floorplan component 500 through exposed in-ports 510, out-ports 515, bindings 520 and configurations 525 elements.

In one embodiment, the in-ports 510 and the out-ports 515 of the component 500 are used to implement a loosely coupled behavior characterized by asynchronous data exchange. The loosely bound components are typically self content, and their behavior is autonomous from parent or triggering components. Alternatively, bindings 520 provide interface for implementing tightly coupled behavior of the component 500. The tightly bound components align its behavior to the parent components and share their same data context. The configurations 525 exposes interfaces to allow technical configuration that usually is statically set at designtime, e.g., to support different styles, different flavors, etc.

Model module 530 defines the data structure of the component 500. In one embodiment, the data structure corresponds to the information to be processed by the software application. The data structure is described in UI data model 535 as it can fit to an enterprise service infrastructure, or to backend data, e.g., business object data structures.

View module 540 provides of the display of the user interface of the component 500. The UI description 545 in view 540 corresponds to the elements of the component 500 UI such as texts, checkbox items, list structures, etc. In one embodiment, the integrated computer environment allows definitions of customized or custom UI components 550 wrapped by the component 500. The UI elements as described in 545, and any customized components as declared in 550, bind or fit to the UI data model 535. The UI elements trigger corresponding event handlers when manipulated by users.

Controller module 555 manages the communication of data and sets the rules used to manipulate the data exchanged by the component. The controller 555 includes event handlers 560. In one embodiment, there are different kinds of event handlers 560 encompassing different activities when triggered. For example, event handler 560 may invoke action 565. Generally, the action 565 is exposed by the enterprise service infrastructure or by the application platform, e.g., by a business object defined in the application platform.

In one embodiment, event handler 560 may support scripting. For example, access to the UI data model 535 to read and set values may be acquired through script 570. Event handlers 560 may use predefined query 575 to extract data from the backend into the UI data model 535, or directly to feed the extracted data into a corresponding list structure of the view 540. Further, event handlers 560 may invoke navigation or dataflow to an embedded component through plug 580. In one embodiment, navigation 585 provides context-mapping for out-plug and in-plug operations, e.g. for plug operations involving other components.

FIG. 6 shows GUI 600 of an integrated environment for software design and implementation, according to one embodiment. The GUI 600 is divided in several areas. Floorplans container 605 is an area where a set of general floorplan components is presented. The floorplans components may be sorted by type or by main UI component, and listed in a folder-like manner grouped by established criteria. The floorplans included in the floorplans container 605 may be predefined and supported by the integrated environment.

Design areas 610, 615, 620 and 625 are available to different stake holders working with the integrated environment to accomplish activities like describing use cases, defining screenflows corresponding to the use cases, generating interaction diagrams, etc. The design areas 610 to 625 may be used to define detailed components of general floorplans selected from the floorplans container area 605. The different design areas may be used for different activities by a single or numerous stakeholders at a time. For example, design area 610 may show the UI data model of a particular floorplan component; the UI description of the same or of another floorplan component may be displayed in design area 615; the design area 620 may show a floorplan component details in controller mode; etc. The number and the display arrangement of the design areas 610 to 625 may vary. For example, user may chose which of the design areas 610 to 625 to be displayed at a particular moment.

Business object (BO) attributes 630 is an area of the GUI 600 where attributes pertinent to the backend platform are listed, e.g. data fields, methods, actions, relationships, etc. The BO attributes area 630 may order the attributes either by type, by relevancy, by business object, etc. The entries of the BO attributes area 630 may be presented in folder-like manner, or in any other convenient form. In one embodiment, the BO attributes area 630 provides a browser-like interface to a user to explore the backend structure of an application platform, e.g., the defined BO and their characteristics.

In one embodiment, one or more elements of the floorplans included in a software application design needs to be mapped or bound to some of the attributes in BO attributes area 630. The mapping may be accomplished by drag-and-drop operations from the BO attributes area 630 to the design areas 610 to 625. The detailed definition of a component of a floorplan may depend on the binding to corresponding BO attribute. Alternatively, a component may be drag-and-dropped from one of the design areas 610 to 625 in BO attributes area 630 over a corresponding BO element to establish the binding. For example, a data field from the data model of a component may be dragged to a corresponding data field of a BO to bind the two data fields. In one embodiment, after the binding to the BO attributes, the software application is considered implemented, and can be executed in a runtime environment.

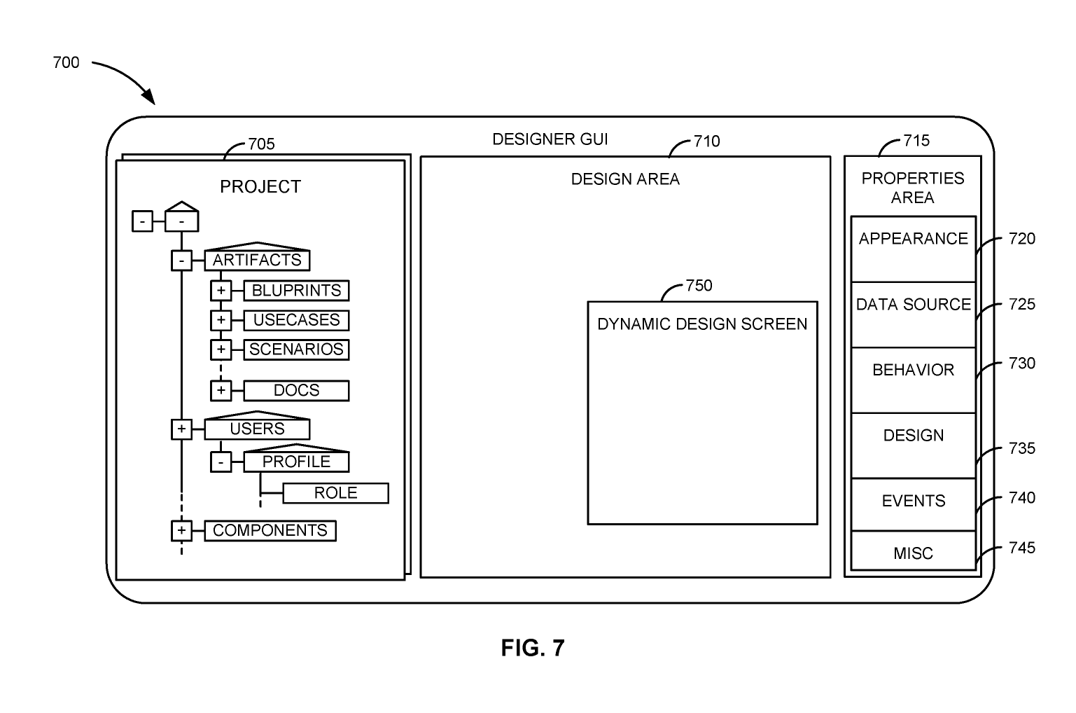

FIG. 7 shows another GUI 700 of the integrated environment for software design and implementation, according to one embodiment. The GUI 700 forms several areas including project 705, design area 710 and properties area 715. Project area 705 may cluster a number of projects regarding the design and implementation of one or more software applications. The elements of each of the current projects may be organized in a folder-like manner, and displayed in the project area 705, one or more projects at a time. The elements of the projects may be grouped under artifacts of different kinds, e.g., blueprints project guides, use cases, business scenarios, relevant documents and messages, etc. For a project, definition of user rights to access different elements of the project may be also provided and displayed in the project area, e.g. by stakeholders or roles.

In an embodiment, a set of relevant UI components may be also included in the project screen 705. The UI components may be used during software application design phase of the project. Further, the project screen 705 may provide a solution explorer, e.g., access to the file structure of the design definitions of the corresponding software application. For example, the design of the UI components and the functional dependencies between the components may be stored in files into the backend or frontend file systems. The project screen 705 may transform to a file system explorer to show the files with the design definitions. In one embodiment, the project screen 705 may also be used by the shareholders to collaborate on project or entity level.

The design area 710 provides space for designing or developing the UI components of a software application corresponding to a specific project. In one embodiment, the design area 710 may be used by different stakeholders to perform activities pertinent to different lifecycle phases of the software application. For example, a user may define details for one or more of the components of a specific floorplan that is part of the software application. The design area 710 may be set in different modes in accordance with the stakeholder's needs. For example, design area may show source code underlying an UI component to an application developer stakeholder in either development or debug mode. In another mode, design area 710 may provide wireframe for designing the way UI components appear in runtime. In yet another mode, the design area 710 may show different elements from the structure of a component of the software application, e.g., one of the data model structure, the view characteristics of the component, or a controller interface for setting up the component's behavior.

The properties area 715 enlists the properties or the characteristics of a specific component or group of components. For example, when a stakeholder works on the design of a particular UI component in the design area 710, the properties area 715 may provide the current characteristics of the UI component. In one embodiment, the characteristics or the properties of a UI component may include appearance properties 720 showing the form or the dimensions of the UI component. Further, properties specifying an underlying data structure from the UI data model may be grouped as data source 725. Behavior 730 enlists properties concerning the way the UI appearance may change during runtime. Design 735 specifies properties for the UI component design definition itself, and events 740 may specify a system or user action to trigger a corresponding action in the software application. The properties included in miscellaneous 745 group regard characteristics of the UI component not included in the rest of the properties groups, like for instance, the components name.

The properties of the UI component may be defined during the UI design within the design area 710. For example, when the appearance of the UI component is defined in a wireframe editor within the design area 710, the dimension properties in appearance group 720 are automatically set. Alternatively, a user may invoke dynamic design screen 750 by clicking on any of the properties in properties area 715 to define the properties directly. The dynamic design screen 750 may be invoked by other user actions during the UI component design. For example, dynamic design screen 750 may help to work in different design modes simultaneously, e.g., by showing the controller mode of the UI component to define an event while the UI component currently being manipulated in a view mode or in a data model mode. The dynamic design screen 750 may show source code pertinent to an element of the UI component being designed in the design area 710, etc.

In one embodiment, the integrated environment for software design and implementation provides a pattern based configuration of the separate UI components. This configuration may include using predefined building blocks offered by the framework, and assembling with these blocks the UIs and the controller logic. The framework upon which the integrated environment operates may offer low-level building blocks, e.g., controls, to be included into a floorplan. Additionally, the framework may provide higher-level building blocks, e.g., BrowseAndCollect-patterns, Calendar components, GanttChartPane components, etc. In one embodiment, the components offered by the framework may be defined with a domain-specific Extensible Markup Language (XML) Schema Definition (XSD) description. The domain-specific XSD may be used to generate an object model for the integrated environment for software design and implementation, where the object model may be used to serialize and de-serialize an XML instance of a UI component definition.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

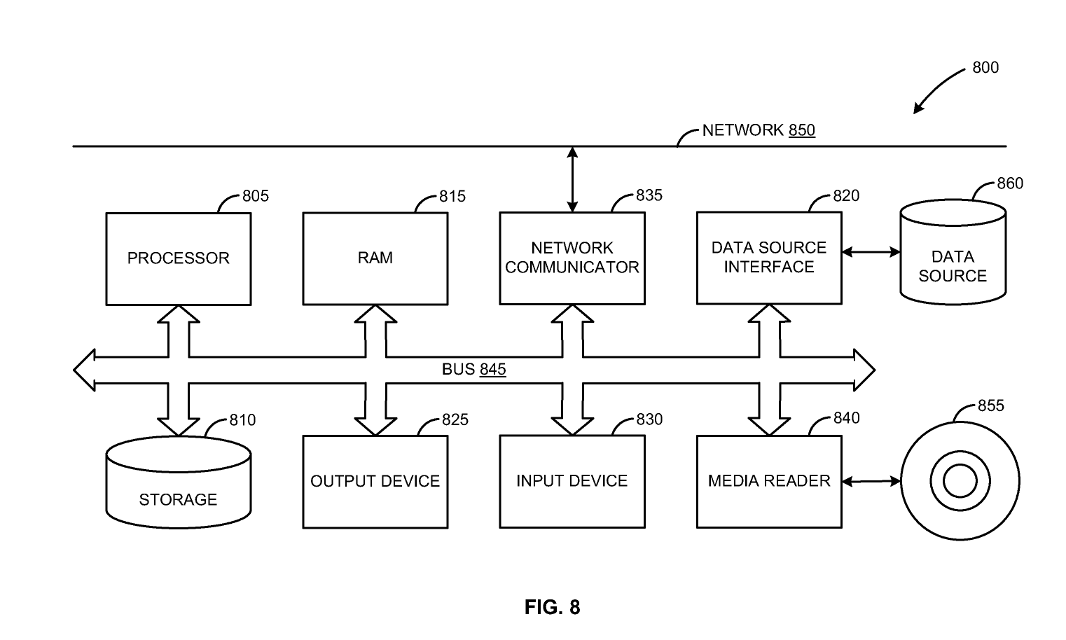

FIG. 8 is a block diagram of an exemplary computer system 800. The computer system 800 includes a processor 805 that executes software instructions or code stored on a computer readable storage medium 855 to perform the above-illustrated methods of the invention. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment of the invention, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a non-transitory computer readable storage medium to tangibly store instructions, which when executed by a computer, cause the computer to:
group a plurality of base floorplans, wherein each floorplan of the plurality of floorplans includes at least one general user interface (UI) component;
generate at least one primary screenflow corresponding to a first use case, wherein the at least one primary screenflow includes a first set of floorplans of the plurality of floorplans configured to represent at least one primary sequence of UI controls for executing at least one task of first use case;
generate at least one secondary screenflow corresponding to a second use case, wherein the at least one secondary screenflow includes a second set of floorplans of the plurality of floorplans configured to represent at least one secondary sequence of UI components for executing at least one task of the second use case;
combine the at least one primary screenflow with the at least one secondary screenflow into a normalized interaction diagram representing the at least one primary sequence of UI controls and the at least one secondary sequence of UI components; and
bind at least one floorplan from the plurality of floorplans to a data structure corresponding to at least one business object (BO) in a backend system, wherein the at least one floorplan is included in the normalized interaction diagram.

2. The article of manufacture of claim 1, wherein the non-transitory computer readable storage medium tangibly stores further instructions, which when executed by a computer cause the computer to:
assign a first type of user profiles to initiate the generation of the at least one primary screenflow;
assign a second type of user profiles to initiate the combination of the at least one primary screenflow with the at least one secondary screenflow into the normalized interaction diagram; and
assigning a third type of user profiles to initiate the binding of the at least one floorplan from the plurality of floorplans to the data structure corresponding to the at least one BO.

3. The article of manufacture of claim 1, wherein the non-transitory computer readable storage medium tangibly stores further instructions, which when executed by a computer cause the computer to:
receive BO metadata from the backend computer system, wherein the BO metadata includes one or more of a description of the fields structure of the at least one BO, at least one relationship to another BO, and at least one method definition of the BO; and
send UI metadata to the backend computer system to allow a third party execution of the at least one task of the first use case or the at least one task of the second use case over the at least one BO, wherein the UI metadata includes description of the first set and the second set of floorplans and the binding of the at least one floorplan included in the normalized interaction diagram to the data structure corresponding to the at least one BO.

4. The article of manufacture of claim 3, wherein the non-transitory computer readable storage medium tangibly stores further instructions, which when executed by a computer cause the computer to:
generate a second version of the interaction diagram reflecting a change in a floorplan of the first set of floorplans corresponding to a change in the first use case; and
send a second version of the UI metadata corresponding to the second version of the interaction diagram to allow the third party execution of at least one task of the changed first use case.

5. The article of manufacture of claim 1, wherein generating the at least one primary screenflow comprises:
defining a source floorplan of the first set of floorplans;
defining a target floorplan from the first set of floorplans; and
defining a condition to navigate from a base UI component of the source floorplan to a base UI component of the target floorplan during runtime.

6. The article of manufacture of claim 1, wherein generating the at least one primary screenflow comprises:
generating a detailed specification of an instance of a floorplan of the first set of floorplans, wherein the detailed specification includes one or more categories of components selected from a group consisting of
a view defining at least one customized UI component deriving from a general UI component,
a data model describing at least one data structure component corresponding to the at least one customized UI control component, and
a controller defining at least one event handler component to initiate an action corresponding to one or more of a system event, user action and a context.

7. The article of manufacture of claim 1, wherein generating the at least one primary screenflow comprises:
relating a general UI component of a first floorplan of the first set of floorplans to a general UI component of a second floorplan of the first set of floorplans; and
relating a customized UI component deriving from the general UI component of the first floorplan of the first set of floorplans with the general UI component of the second floorplan of the first set of floorplans, or with a customized UI component deriving from the general UI component of the second floorplan of the first set of floorplans.

8. A computer implemented method for a business application development and implementation within an integrated environment, the method comprising:
connecting a first floorplan to a second floorplan with a first connection to form a first screenflow corresponding to a first business scenario;
connecting the first floorplan to a second floorplan with a second connection to form a second screenflow corresponding to a second business scenario;
combining the first screenflow with the second screenflow into an interaction diagram corresponding to the first business scenario and to the second business scenario, wherein the first floorplan is aggregated; and
assigning the floorplans and the connections between floorplans in the interaction diagram to at least one business object (BO) based on BO metadata stored in a backend computer system; and
storing user interface (UI) metadata in the backend computer system to allow a third party execution of the business scenarios over the at least one BO, wherein the UI metadata includes a description of the floorplans and the connections in the interaction diagram.

9. The method of claim 8 further comprising:
assigning to a first role system rights to initiate the connection of the first floorplan with the second floorplan into the first screenflow;
assigning to a second role system rights to initiate the combination of the first screenflow and the second screenflow into the interaction diagram;
assigning to a third role system rights to initiate the assignment of the floorplans and the connections between floorplans to the at least one BO; and
assigning a user profile to one or more roles selected from a group consisting of the first role, the second role and the third role.

10. The method of claim 8 further comprising:
maintaining a general specification of the first floorplan containing a base UI control.

11. The method of claim 8, wherein connecting the first plan to the second floorplan with the first connection comprises:
defining a source UI control of the first floorplan and a target UI control of the second floorplan to navigate between the floorplans during runtime when a predefined condition is met.

12. The method of claim 8, wherein assigning the floorplans and the connections between floorplans in the interaction diagram to the at least one BO comprises:
receiving a detailed specification of an instance of the first floorplan, wherein the detailed specification includes a plurality of components of one or more categories selected from a group consisting of
a view category defining at least one customized UI control component corresponding to the base UI control,
a data model category describing at least one data structure component corresponding to at least one component of the floorplan, and
a controller category defining at least one event handler to be associated with an component of the floorplan to initiate an action corresponding to one or more of a system event, user action and a context.

13. The method of claim 12, wherein receiving the detailed specification of the instance of the first floorplan comprises:
generating the detailed specification of the instance of the first floorplan based on one or more of a user input and BO metadata import from the backend computer system.

14. The method of claim 12 further comprising:
assigning a user profile to an component of the plurality components included in the detailed specification of the instance of the first floorplan, wherein the user profile is responsible for the detailed specification of the component

15. The method of claim 8, wherein assigning the floorplans and the connections between floorplans in the interaction diagram to the at least one BO comprises:
receiving a detailed specification of a relationship between a customized UI component of an instance of the first floorplan and a customized UI component of an instance of the second floorplan.

16. A computer system for application development and implementation within an integrated environment, the system comprising:
a memory to store computer instructions, wherein the memory is connected to a backend computer system via network; and
a processor coupled to the memory to execute the computer instructions to
maintain at least one project container including items of one or more integrated categories selected from a group consisting of use cases, documents, user profiles, roles, floorplans and cross project items,
display at least one floorplan from a plurality of floorplans of an interaction diagram for the at least one project,
generate a list of at least one screenflow aggregated into the interaction diagram, wherein the at least one screenflow includes the at least one floorplan, and
maintain a correspondence between the at least one floorplan and at least one business object (BO) defined in the backend computer system.

17. The computer system of claim 16, wherein displaying the at least one floorplan comprises:
rendering a graphical user interface (GUI) including
a first area showing a schematic view of the at least one floorplan and at least one relationship modeled to connect the at least one floorplan with at least one other floorplan, and
a second area showing the list of the at least one screenflow.

18. The computer system of claim 16, wherein displaying the at least one floorplan comprises:
rendering a GUI showing a detailed view of the at least one floorplan, wherein the detailed view includes at least one screen selected from a group consisting of
a data model screen showing a data structure underlying at least one component of the at least one floorplan,
a controller screen showing at least one definition of an event handler associated with an component of the at least one floorplan, and
a user interface (UI) view screen showing a representation of a customized UI component of the at least one floorplan.

19. The computer system of claim 16, wherein displaying the at least one floorplan comprises:
rendering a GUI to switch between a schematic view and detailed view of the at least one floorplan enabling drill-down design or analysis of the components of the at least one floorplan, wherein the GUI switching between views is in response to a user action or to a system event.

20. The computer system of claim 16, wherein generating the list of the at least one screenflow comprises:
generating a statistical data related to the at least one screenflow in order to provide monitoring information regarding the execution of a task of a use case corresponding to the at least one screenflow.
